(19) United States
(12) Patent Application Publication
(10) Pub. No.: US 2014/0190603 A1
(43) Pub. Date: Jul. 10, 2014

(54) PROTECTIVE VEHICLE WRAP

(71) Applicant: LEOLA CLIETT, PHILADELPHIA, PA (US)

(72) Inventor: LEOLA CLIETT, PHILADELPHIA, PA (US)

(21) Appl. No.: 13/735,122

(22) Filed: Jan. 7, 2013

(51) Int. Cl. B60J 11/06

(52) U.S. Cl. CPC B60J 11/06
USPC 150/166

(57) ABSTRACT

A device for protecting an outer surface of a vehicle and a method of use thereof including: a plurality of polyethylene bubbles formed on a cloth like material from a band of a predetermined width; cords extending from the band, where said cords enable the placement and fixture of the band around the outer surface of the vehicle; and at least one lock, where said lock secures the cords in a fixed and locked position after placement of the band around the vehicle. In the preferred embodiment, the band extends across a rear bumper, along both sides of the vehicle and a front bumper.

### BACKGROUND OF THE INVENTION

1. Field of Invention

The present invention relates to a protective vehicle wrap to protect the outer surface of a vehicle.

2. Description of Related Art

Many times individuals must park their vehicle in a public parking space and subject the vehicle to potential scratches, dings and dents due to adjoining parked cars. Sometimes occasionally cars scrape against adjoining cars when parking in an adjoining parking space. Consequently many cars have scratches or scrapes along the side panels and along the bumpers and therefore diminishes the overall look and appearance of the vehicle. Due to the scratches and scrapes the vehicle's value further diminishes for possible resale. Also occasionally vandals scrape cars through key scrapes or other scratches while a vehicle is parked and unattended. Although there are some pads for vehicles to protect their bumpers, the side panels still are exposed and therefore it would be advantageous to have a protective barrier to protect the outer surface of a vehicle while it is in a parked position.

### SUMMARY OF THE INVENTION

The present invention relates to a device for protecting an outer surface of a vehicle comprising: a plurality of polyethylene bubbles formed on a cloth like material from a band of a predetermined width; cords extending from the band, where said cords enable the placement and fixture of the band around the outer surface of the vehicle; and at least one lock, where said lock secures the cords in a fixed and locked position after placement of the band around the vehicle. In the preferred embodiment, the band extends across a rear bumper, along both sides of the vehicle and a front bumper.

The present invention also relates to a method of protecting the outer surface of a vehicle comprising the steps of: attaching a first end of a band of polyethylene bubbles to a rear bumper of the vehicle; extending the band along a first side of the vehicle from the rear bumper; wrapping the band over a front bumper from the first side of the vehicle; extending the band along a second side of the vehicle from the front bumper; and connecting a second end of the band to the rear bumper from the second side of the vehicle; securing the band in place by using cords extending from the band; and locking the cords to prevent removal of the band.

### BRIEF DESCRIPTION OF DRAWINGS

FIG. 1 depicts a prospective view of a protective vehicle wrap in accordance with the present invention.

### DETAILED DESCRIPTION

The present invention relates to a protective vehicle wrap that is utilized by an owner to protect the outer surface in particular the side panels, doors, rear bumpers and front bumpers of a vehicle when it is in a parked position. The vehicle wrap in accordance with the present invention is a bubble wrap and cloth type material that is secured around the vehicle through the use of security cords and locks. The wrap protects the outer surface of a vehicle from scratches, dings and nicks.

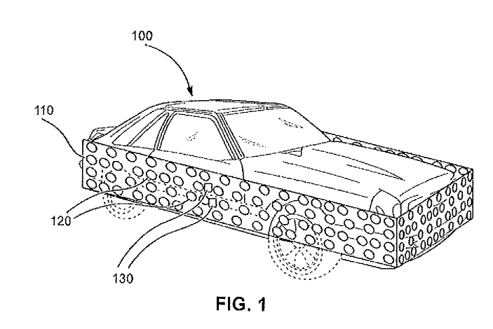

In reference to FIG. 1, a system for protecting a vehicle is depicted. The system includes the protective wrap 110 as shown in FIG. 1. As shown, the protective wrap 110 extends around the side panels, door, front and rear bumpers of a vehicle 100. The vehicle's 100 outer surface is therefore protected from any scrapes and scratches that could potentially occur within a parking space. Security cords 120 are available that allow the user to tighten and secure the wrap 110 in a secure position on the outer surface of the vehicle 100. Locks 130 are also used to secure the cords so that the wrap is not stolen and removed from the vehicle. The wrap 110 is placed initially upon a license plate at the rear of the vehicle and then extends around the back bumper along one side, forward to the front bumper, then back along the opposite side to the rear bumper and then secured with the use of the security cords 120 provided.

The vehicle wrap 110 therefore allows a user to protect the vehicle surface without obstructing the license plate. Visibility of the license plate is a key feature since it is important for the vehicle license plate to be visible at all times for authorities. As shown in FIG. 1 the wrap 110 includes a series of bubbles. The bubble wrap is formed of polyethylene film that has a bonded side and then a flat side to form an air bubble. The bubbles are shown on the wrap 110; therefore provides a protective cushioning for the surface of the vehicle. The size of the bubbles can vary in diameter and more than likely in one preferred embodiment may be of a smaller diameter to avoid excessive popping or damage of the bubbles during use. The instant invention has been shown and described in what it considers to be the most practical and preferred embodiments. It is recognized, however, that departures may be made there from within the scope of the invention and that obvious modifications will occur to a person skilled in the art.

What is claimed is:

1. A device for protecting an outer surface of a vehicle comprising:
a. a plurality of polyethylene bubbles formed on a cloth like material from a band of a predetermined width;
b. cords extending from the band, where said cords enable the placement and fixture of the band around the outer surface of the vehicle; and
c. at least one lock, where said lock secures the cords in a fixed and locked position after placement of the band around the vehicle.

2. The device according to claim 1 where the band extends across a rear bumper, along both sides of the vehicle and a front bumper.

3. A method of protecting the outer surface of a vehicle comprising the steps of:
a. attaching a first end of a band of polyethylene bubbles to a rear bumper of the vehicle;
b. extending the band along a first side of the vehicle from the rear bumper;
c. wrapping the band over a front bumper from the first side of the vehicle;
d. extending the band along a second side of the vehicle from the front bumper; and
e. connecting a second end of the band to the rear bumper from the second side of the vehicle;
f. securing the band in place by using cords extending from the band; and
g. locking the cords to prevent removal of the band.
